(19) United States
(12) Patent Application Publication
(10) Pub. No.: US 2012/0313551 A1
(43) Pub. Date: Dec. 13, 2012

(54) Lamp Device

(75) Inventors: Hiromichi NAKAJIMA, Yokosuka-shi (JP); Yuichiro TAKAHARA, Yokosuka-shi (JP); Hiroshi MATSUSHITA, Yokosuka-shi (JP); Masahiro TODA, Yokosuka-shi (JP); Shigeru OSAWA, Yokosuka-shi (JP); Ryotaro MATSUDA, Yokosuka-shi (JP); Jun SASAKI, Yokosuka-shi (JP); Takeshi OSADA, Yokosuka-shi (JP)

(73) Assignee: TOSHIBA LIGHTING & TECHNOLOGY CORPORATION, Yokosuka-shi (JP)

(21) Appl. No.: 13/423,573

(22) Filed: Mar. 19, 2012

(30) Foreign Application Priority Data
Jun. 10, 2011 (JP) 2011-130624

(51) Int. Cl. H05B 37/02

(52) U.S. Cl. 315/309

(57) ABSTRACT

According to one embodiment, a lamp device includes a housing including a cap, a light-emitting module arranged in the housing and a lighting circuit. The light-emitting module includes a module board, and a semiconductor light-emitting element mounted on the module board. The lighting circuit includes a circuit board, plural circuit components mounted on the circuit board, and a first thermosensor and a second thermosensor arranged at different positions on the circuit board where a temperature difference occurs at time of lighting. The lighting circuit controls lighting of the semiconductor light-emitting element according to the temperature difference between the first thermosensor and the second thermosensor.

### INCORPORATION BY REFERENCE

The present invention claims priority under 35 U.S.C. §119 to Japanese Patent Application No. 2011-130624 filed on Jun. 10, 2011. The content of the application is incorporated herein by reference in their entirety.

### FIELD

Embodiments described herein relate generally to a lamp device using a semiconductor light-emitting element as a light source.

### BACKGROUND

Hitherto, there is a luminaire using a combination of a lamp device using a flat cap such as, for example, a GX53-type cap and an equipment device including a socket on which the cap of the lamp device is detachably mounted.

The lamp device includes a housing including the cap, an LED arranged in the housing, and a lighting circuit to light the LED. The structure is such that at the time of lighting of the LED, heat generated by the LED is conducted from the housing to the equipment device and is radiated.

For example, if plural kinds of lamp devices are provided according to a difference in light output, and plural kinds of equipment devices suitable for the respective kinds of lamp devices are provided, the suitable kinds of lamp devices and equipment devices are combined and used.

However, when caps and sockets are common irrespective of the kind of the lamp device and the kind of the equipment device, even in unsuitable kind of combination, the lamp device can be mounted on the equipment device. If a lamp device having large output is mounted on an equipment device corresponding to a lamp device having small output, the equipment device corresponding to the lamp device having small output can not sufficiently discharge heat generated by the lamp device having large output, and there is a fear that abnormal thermal radiation of the lamp device occurs.

An exemplary embodiment described herein provides a lamp device which detects abnormal thermal radiation at the time of lighting and can control the lighting of a semiconductor light-emitting element.

### DESCRIPTION OF THE DRAWINGS

FIG. 1 is a sectional view of a lamp device of a first embodiment.

FIG. 2 is a front view of a lighting circuit of the lamp device.

FIG. 3 is a sectional view of a luminaire in which the lamp device and an equipment device are combined.

FIG. 4 is a front view of a lighting circuit of a lamp device of a second embodiment.

FIG. 5 is a front view of a lighting circuit and a light-emitting module of a lamp device of a third embodiment.

FIG. 6 is a sectional view of a lamp device of a fourth embodiment.

FIG. 7 is a sectional view of a lamp device of a fifth embodiment.

FIG. 8 is a circuit view of a part of a lighting circuit of a lamp device of a sixth embodiment.

FIG. 9 is a circuit view of a part of a lighting circuit of a lamp device of a seventh embodiment.

### DETAILED DESCRIPTION

In general, according to one embodiment, a lamp device includes a housing including a cap, a light-emitting module arranged in the housing and a lighting circuit. The light-emitting module includes a module board, and a semiconductor light-emitting element mounted on the module board. The lighting circuit includes a circuit board, plural circuit components mounted on the circuit board, and a first thermosensor and a second thermosensor arranged at different positions on the circuit board where a temperature difference occurs at the time of lighting. The lighting circuit controls lighting of the semiconductor light-emitting element according to the temperature difference between the first thermosensor and the second thermosensor.

According to the lamp device of the embodiment, abnormal thermal radiation at the time of lighting can be certainly detected based on the temperature difference between the first thermosensor and the second thermosensor, and control of the semiconductor light-emitting element, for example, turning off or dimming of the semiconductor light-emitting element can be expected to be performed according to that.

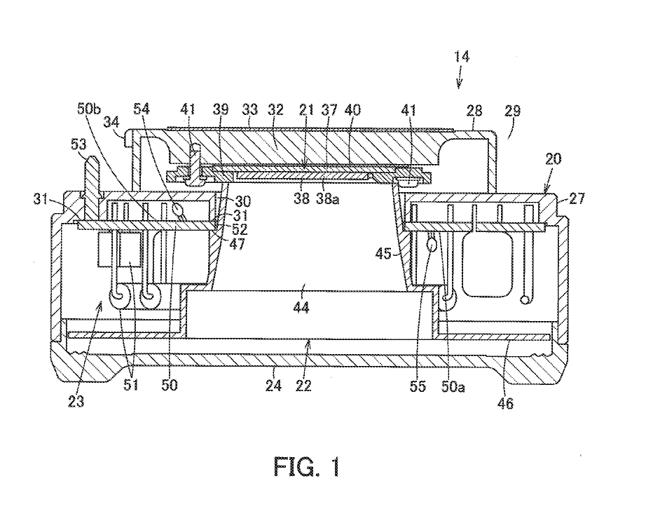

Next, a first embodiment will be described with reference to FIG. 1 to FIG. 3.

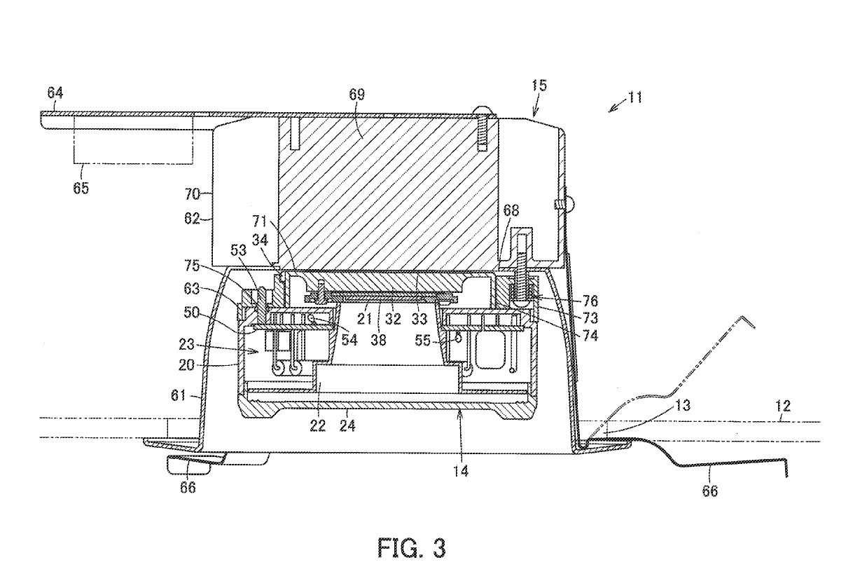

As shown in FIG. 3, a luminaire 11 is an embedded luminaire such as a downlight, and is installed to be embedded in a circular embedding hole 13 provided in a ceiling plate 12. The luminaire 11 includes a flat lamp device 14, and an equipment device 15 on which the lamp device 14 is detachably mounted.

As shown in FIG. 1, the lamp device 14 includes a flat cylindrical housing 20. A light-emitting module 21, an optical component 22 and a lighting circuit 23 are arranged in the housing 20, and a translucent cover 24 is attached to a lower surface of the housing 20.

The housing 20 includes a cylindrical case 27 and a cylindrical cap member 28 attached to an upper side of the case 27. A cap 29 having a specified standard size is constructed of the upper side part of the case 27 and the cap member 28.

The case 27 is made of, for example, a synthetic resin having an insulating property and is formed into a cylindrical shape having an upper surface part, a peripheral surface part and an opened lower surface. An optical component insertion hole 30 through which the optical component 22 is inserted is formed at the center of the upper surface part of the case 27. An annular board support part 31 to support the lighting circuit 23 (circuit board) is formed at the periphery of the upper surface part of the case 27 and the edge part of the optical component insertion hole 30.

The cap member 28 is made of, for example, a metal such as an aluminum die cast, ceramic or material such as resin excellent in thermal conductivity, and is formed into a cylindrical shape having an upper surface part, a peripheral surface part and an opened lower surface. The cap member 28 is attached to the case 27 by plural screws threaded to the cap member 28 through the upper surface part of the case 27.

A light-emitting module attachment part 32 protruding downward from the upper surface part of the cap member 28 is integrally formed on the upper surface part of the cap member 28. The light-emitting module 21 is attached to the lower surface of the light-emitting module attachment part 32. A thermal conductive sheet 33 is attached to the upper surface of the cap member 28. Besides, plural keys 34 are formed to protrude from the peripheral surface part of the cap member 28, and plural substantially L-shaped key grooves are formed.

The light-emitting module 21 includes a module board 37, a light-emitting part 38 formed on the lower surface of the module board 37, a frame-shaped holder 39 to hold the periphery of the module board 37, and a thermal conductive sheet 40 interposed between the module board 37 and the light-emitting module attachment part 32 to which the module board 37 is attached.

The module board 37 is made of a material such as, for example, metal excellent in thermal conductivity or ceramic and is formed into a flat plate shape.

In the light-emitting part 38, a semiconductor light-emitting element 38a, such as an LED element or an EL element, is used as a light source. In this embodiment, an LED element is used as the semiconductor light-emitting element 38a, and a COB (Chip On Board) system is adopted in which plural LED elements are mounted on the module board 37. That is, the plural LED elements are mounted on the module board 37, the plural LED elements are electrically connected in series to each other by wire bonding, and the plural LED elements are integrally covered and sealed with a phosphor layer as a transparent resin, such as silicone resin, in which phosphor is mixed. As the LED element, for example, an LED element to emit blue light is used, and a phosphor which is excited by part of the blue light from the LED element and emits yellow light is mixed in the phosphor layer. Accordingly, the light-emitting part 38 is composed of the LED elements, the phosphor layer and the like, the surface of the phosphor layer as the surface of the light-emitting part 38 becomes a light-emitting surface, and white illumination light is emitted from the light-emitting surface. Incidentally, as the light-emitting part 38, a system may be used in which plural SMD (Surface Mount Device) packages with connection terminals on which LED elements are mounted on the board.

The holder 39 holds the module board 37 and is fixed to the light-emitting module attachment part 32 by plural screws in a state where the thermal conductive sheet 40 and the module board 37 are sandwiched between the holder and the light-emitting module attachment part 32. By the holder 39, the module board 37 is brought into close contact with the light-emitting module attachment part 32 of the cap member 28 through the thermal conductive sheet 40, and excellent thermal conductivity from the module board 37 to the cap member 28 is secured.

The optical component 22 is formed of a cylindrical reflector 44. The reflector 44 is made of, for example, a synthetic resin having an insulating property, and a cylindrical light guide part 45 is formed whose upper and lower surfaces are opened and whose diameter is stepwise or continuously increased from an upper end side to a lower end side. An annular cover part 46 to cover the lower surface periphery of the case 27 is formed at the lower end of the light guide part 45. A reflecting surface having a high optical reflectance, which is made, for example, a white or mirror surface, is formed on the inner surface of the light guide part 45 and the lower surface of the cover part 46.

An upper part side of the light guide part 45 passes through the lighting circuit 23 (circuit board) and the optical component insertion hole 30 of the case 27, and is arranged around the light-emitting part 38 of the light-emitting module 21. A board holding part 47 to hold the lighting circuit 23 (circuit board) between itself and the board support part 31 of the case 27 is formed on the outer peripheral surface of the light guide part 45 and at an intermediate part in the up and down direction.

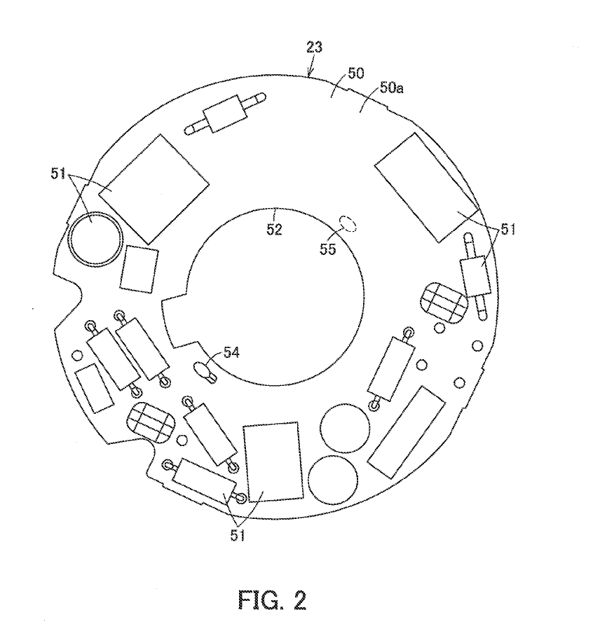

Besides, as shown in FIG. 1 and FIG. 2, the lighting circuit 23 includes, for example, a power supply circuit to rectify, smooth and convert commercial AC power supply into DC power supply, a DC/DC converter to supply the DC power supply as a specified DC output by switching of a switching element to the LED element and to light the LED element, a control IC to control oscillation of the switching element, and the like. If the lighting circuit 23 supports dimming, the lighting circuit has a function to detect a current of the LED element, to compare the current with a reference value corresponding to a dimming signal, and to control a switching operation of the switching element by the control IC.

The lighting circuit 23 includes a circuit board 50 and circuit components 51 as plural electronic components mounted on the circuit board 50.

The circuit board 50 is formed into an annular shape, and a circular fitting hole 52 through which an upper side of the light guide part 45 of the reflector 44 passes is formed at the center part of the circuit board 50. The lower surface of the circuit board 50 is a mounting surface 50a on which a lead component including a lead wire among the circuit components 51 is mounted, and the upper surface thereof is a connection surface 50b as a wiring pattern surface or a soldering surface, to which the lead wire is connected by soldering, on which a surface mount component among the circuit components 51 is mounted, and which is formed with a wiring pattern.

The circuit board 50 is arranged at an upper position in the case 27 in a state where the connection surface 50b is directed upward and faces the light-emitting module 21 side. The circuit components 51 mounted on the mounting surface 50a of the circuit board 50 are arranged between the peripheral surface part of the case 27 and the light guide part 45 of the reflector 44 and the cover part 46.

A power supply input side of the circuit board 50 is electrically connected to a pair of lamp pins 53 for power supply, and a lighting output side thereof is electrically connected to the LED element of the light-emitting module 21. The pair of lamp pins 53 for power supply vertically protrude from the upper surface part of the case 27. Incidentally, if the lamp device 14 supports dimming, plural lamp pins for dimming vertically protrude from the upper surface part of the case 27 in addition to the lamp pins for power supply.

A first thermosensor 54 constructed of, for example, a thermistor and a second thermosensor 55 are mounted on the circuit board 50. The first thermosensor 54 and the second thermosensor 55 are arranged at different positions on the circuit board 50 where a temperature difference occurs at the time of lighting. In this embodiment, with respect to the mounting surface 50a side of the circuit board 50 and the connection surface 50b side, the temperature of the connection surface 50b side becomes higher than that of the mounting surface 50a side since heat from the circuit components 51 is conducted to the wiring pattern of the connection surface 50b and the connection surface 50b side is liable to receive the influence of heat from the LED element. Thus, the first thermosensor 54 is arranged on the connection surface 50b side of the circuit board 50, and the second thermosensor 55 is arranged on the mounting surface 50a side of the circuit board 50.

The lighting circuit 23 controls the lighting of the LED element according to the temperature difference between the first thermosensor 54 and the second thermosensor 55. Specifically, if the temperature difference becomes a previously set temperature difference or higher, the control circuit performs turning-off control of the LED element, or if the lamp device 14 supports dimming, the light control circuit performs dimming control to reduce the output of the LED element. When the turning-off control of the LED element is performed, for example, the control IC determines that the temperature difference is the specified temperature difference or higher, and stops the oscillation of the switching element of the DC/DC converter. Besides, when the dimming control of the LED element is performed, for example, the control IC determines that the temperature difference is the previously set temperature difference or higher, and performs dimming to reduce the output of the LED element based on a voltage value obtained by adding a specified dummy voltage to an actual detected voltage of the LED element, or performs dimming to reduce the output of the LED element by changing a threshold of a reference value corresponding to a dimming signal with which the detected current of the LED element is compared.

The translucent cover 24 has a transparent property and a diffusion property, and is formed of, for example, synthetic resin or glass into a disk shape. The translucent cover 24 covers the opening part of the lower surface of the case 27 and is attached to the case 27. In the attachment state, the cover part 46 of the reflector 44 is sandwiched and held between the translucent cover 24 and the case 27.

Next, as shown in FIG. 3, the equipment device 15 includes a reflector 61 expanded and opened downward, a thermal radiator 62 as an equipment main body attached to the upper part of the reflector 61, a socket 63 attached to the lower part of the thermal radiator 62, a terminal stand 65 attached to the upper part of the thermal radiator 62 by an attachment plate 64, and plural attachment springs 66 for ceiling attachment attached to the periphery of the thermal radiator 62.

A circular opening 68 through which the thermal radiator 62 is exposed is formed at a top part of the reflector 61.

Besides, the thermal radiator 62 is made of, for example, a metal such as an aluminum die cast, ceramic or material such as resin excellent in thermal radiation. The thermal radiator 62 includes a cylindrical base part 69 and plural thermal radiation fins 70 radially protruding from the periphery of the base part 69. A flat contact surface 71 exposed in the reflector 61 through the opening 68 of the reflector 61 is formed on the lower surface of the base part 69. The attachment springs 66 are attached to the periphery of the base part 69.

The socket 63 includes a socket main body 73 made of a synthetic resin having an insulation property and formed into an annular shape, and a pair of not-shown terminals for power supply arranged on the socket main body 73. If dimming is supported, plural terminals for dimming are also provided.

A circular opening 74 through which the cap member 28 of the lamp device 14 is inserted is formed at the center of the socket main body 73. Plural connection holes 75 in which the lamp pins 53 of the lamp device 14 are inserted are formed into a long-hole shape along the circumferential direction in the lower surface of the socket main body 73. Terminals are arranged on the upper sides of the respective connection holes 75, and the lamp pins 53 of the lamp device 14 inserted in the connection holes 75 are electrically connected to the terminals.

Plural keys are formed to protrude from the inner peripheral surface of the socket main body 73, and plural substantially L-shaped key grooves are formed. The keys and the key grooves of the socket 63 and the key grooves and the keys 34 of the lamp device 14 are respectively provided at corresponding positions. The keys 34 and the key grooves of the lamp device 14 are matched to the key grooves and the keys of the socket 63, the cap 29 of the lamp device 14 is inserted in the socket 63, and the lamp device 14 is rotated, so that the lamp device 14 can be detachably mounted on the socket 63.

The socket 63 is supported to the thermal radiator 62 by a support mechanism 76. In the support mechanism 76, the cap 29 of the lamp device 14 is mounted on the socket 63, so that the upper surface of the cap 29 is pressed to the contact surface 71 of the thermal radiator 62 and the thermal conductivity is raised.

The terminal stand 65 is electrically connected to the terminal of the socket 63.

In the luminaire 11 including the lamp device 14 and the equipment device 15 as stated above, in order to mount the lamp device 14 on the equipment device 15, the cap 29 of the lamp device 14 is inserted in the socket 63 of the equipment device 15 and is rotated by a specified angle. By this, the respective keys 34 and the key grooves of the cap 29 and the respective key grooves and the keys of the socket 63 are fitted to each other and are hooked, and the lamp device 14 can be attached to the socket 63. At the same time, the respective lamp pins 53 of the cap 29 contact the respective terminals of the socket 63 and are electrically connected. Besides, the upper surface of the cap 29 is pressed to and brought into close contact with the contact surface 71 of the thermal radiator 62 through the thermal conductive sheet 33, and efficient thermal conduction can be performed from the cap 29 to the thermal radiator 62.

Besides, at the time of lighting of the lamp device 14, commercial alternating-current power supply is fed to the lighting circuit 23 through the terminal stand 65, the terminals of the socket 63 and the lamp pins 53 of the lamp device 14. The lighting power is supplied to the LED elements of the light-emitting module 21 by the lighting circuit 23, and the LED elements are lighted. Light emitted from the light-emitting part 38 by the lighting of the LED elements travels in the light guide part 45 of the reflector 44, passes through the translucent cover 24 and is emitted from the lower opening of the equipment device 15.

At the time of lighting of the lamp device 14, the heat generated by the LED elements of the light-emitting module 21 is conducted mainly from the module board 37 of the light-emitting module 21 to the cap member 28, is efficiently conducted from the cap member 28 to the thermal radiator 62 through the thermal conductive sheet 33, and is radiated to the air from the surface of the thermal radiator 62 including the plural thermal radiation fins 70. The heat generated by the lighting circuit 23 is conducted to the case 27 and the translucent cover 24, and is radiated to the air from the surface of the case 27 and the translucent cover 24.

Besides, at the time of lighting of the lamp device 14, with respect to the mounting surface 50a side of the circuit board 50 and the connection surface 50b side, the temperature of the connection surface 50b side becomes higher than that of the mounting surface 50a side since the heat from the circuit components 51 is conducted to the wiring pattern of the connection surface 50b and the connection surface 50b side is liable to receive the influence of the heat from the LED elements.

The lighting circuit 23 acquires the temperature detected by the first thermosensor 54 arranged on the connection surface 50b side of the circuit board 50 and the temperature detected by the second thermosensor 55 arranged on the mounting surface 50a side of the circuit board 50, and monitors the temperature difference.

In the luminaire 11 including the lamp device 14 and the equipment device 15 as stated above, for example, if plural kinds of lamp devices 14 are provided according to the difference of output of the light-emitting module 21, and plural kinds of equipment devices 15 are provided to be suitable for the respective kinds of lamp devices 14 according to the difference of thermal radiation performance, the thermal radiation performance of the equipment device 15 is optimized according to the output of the lamp device 14, and the lamp device 14 and the equipment device 15 are suitably combined and are used.

At this time, even if the lamp device 14 having small output is mounted on the equipment device 15 suitable for the lamp device 14 having high output, the thermal radiation property of the lamp device 14 merely becomes excessive, and desired thermal radiation performance of the lamp device 14 can be achieved. On the other hand, if the lamp device 14 having high output is mounted on the equipment device 15 suitable for the lamp device 14 having small output, desired thermal radiation performance of the lamp device 14 can not be achieved, and there is fear that abnormal thermal radiation of the lamp device 14 occurs.

If the lamp device 14 is mounted on the suitable equipment device 15, or the lamp device 14 having small output is mounted on the equipment device 15 suitable for the lamp device 14 having high output, and the desired thermal radiation performance of the lamp device 14 is achieved, the temperature difference between the temperature detected by the first thermosensor 54 and the temperature detected by the second thermosensor 55 is within a previously set normal range. Accordingly, the lighting circuit 23 determines that the state is normal and continues the lighting of the LED elements.

On the other hand, if the lamp device 14 having high output is mounted on the lamp device 15 suitable for the lamp device 14 having small output and the desired thermal radiation performance of the lamp device 14 is not achieved, as compared with the case where the desired thermal radiation performance is achieved, the temperature of the light-emitting module 21 becomes high. Thus, the heat from the light-emitting module 21 is conducted to the connection surface 50b side of the circuit board 50, the temperature of the connection surface 50b side of the circuit board 50 is liable to be higher than the temperature of the mounting surface 50a side, and the temperature difference between the connection surface 50b side of the circuit board 50 and the mounting surface 50a side becomes large. Accordingly, the temperature difference between the temperature detected by the first thermosensor 54 and the temperature detected by the second thermosensor 55 exceeds the previously set normal range and falls within an abnormal range. By this, the lighting circuit 23 determines that abnormal thermal radiation occurs, and performs turning-off control of the LED elements, or if the lamp device 14 supports dimming, the lighting circuit performs dimming control to reduce the output of the LED elements, and suppresses the heat generation of the light-emitting module 21.

When the temperature difference returns within the normal range by suppressing the heat generation of the lamp device 14, the turning-off control or the dimming control of the LED elements may be continuously maintained or may be returned to the normal-time control.

According to the lamp device 14 of the embodiment, the abnormal thermal radiation at the time of lighting can be certainly detected based on the temperature difference between the first thermosensor 54 and the second thermosensor 55, and the turning-off control or the dimming control of the LED elements is performed according to that, so that the heat generation of the lamp device 14 is suppressed, and the abnormal heat generation of the lamp device 14 can be prevented.

Further, since the abnormal thermal radiation is detected based on the temperature difference between the first thermosensor 54 and the second thermosensor 55 arranged on the different positions on the circuit board 50 where the temperature difference occurs at the time of lighting of the lamp device 14, as compared with the case where the absolute value of temperature is detected only by one thermosensor, a distinction can be easily made between the normal temperature rise and the temperature rise due to the abnormal thermal radiation, and the abnormal thermal radiation can be accurately detected.

Further, at the time of generation of the abnormal thermal radiation of the lamp device 14, with respect to the mounting surface 50a side of the circuit board 50 and the connection surface 50b side, the temperature of the connection surface 50b side, which is liable to receive the heat from the light-emitting module 21, becomes higher than that of the mounting surface 50a side, and the temperature difference clearly occurs. Thus, if the first thermosensor 54 is arranged on the connection surface 50b side of the circuit board 50, and the second thermosensor 55 is arranged on the mounting surface 50a side of the circuit board 50, the occurrence of the abnormal thermal radiation of the lamp device 14 can be certainly detected according to the temperature difference.

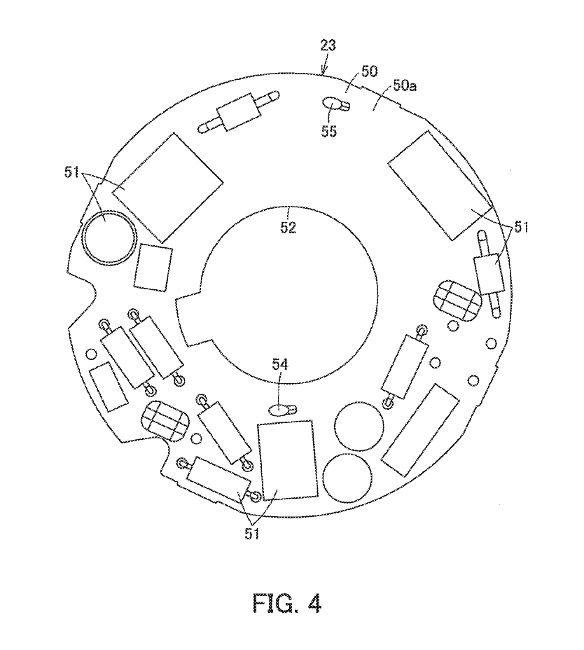

Next, a second embodiment will be described with reference to FIG. 4. Incidentally, the same component as that of the first embodiment is denoted by the same reference numeral and the description thereof is omitted.

As shown in FIG. 4, a first thermosensor 54 is arranged to be closer to a circuit component 51 having large self-heat generation as compared with other circuit components 51 among plural circuit components 51 mounted on a circuit board 50 of a lighting circuit 23 than a second thermosensor 55, and the second thermosensor 55 is arranged to be more distant than the first thermosensor 54.

As the circuit component 51 having large self-heat generation in the lighting circuit 23, for example, a transformer, a diode, a switching element (field effect transistor) and the like are enumerated.

If a lamp device 14 is mounted on a suitable equipment device 15, or the lamp device 14 having small output is mounted on the equipment device 15 suitable for the lamp device 14 having large output, and desired thermal radiation performance of the lamp device 14 is achieved, the temperature detected by the first thermosensor 54 close to the circuit component 51 having large self-heat generation is high, the temperature detected by the second thermosensor 55 distant from the circuit component 51 having large self-heat generation is low, and the temperature difference is a previously set value or higher. Thus, a lighting circuit 23 determines that the state is normal and continues lighting of LED elements.

On the other hand, if the lamp device 14 having large output is mounted on the equipment device 15 suitable for the lamp device 14 having small output and the desired thermal radiation performance of the lamp device 14 is not achieved, as compared with the case where the desired thermal radiation performance of the lamp device 14 is achieved, the temperature of the light-emitting module 21 becomes high, the temperature in the lamp device 14 rises by the heat of the light-emitting module 21, and the detected temperature of the second thermosensor 55 approaches the detected temperature of the first thermosensor 54, or may exceed the detected temperature according to the position of the second thermosensor 55. Thus, the temperature difference between the temperature detected by the first thermosensor 54 and the temperature detected by the second thermosensor 55 becomes smaller than the previously set temperature difference or disappears, or is reversed. By this, the lighting circuit 23 determines that abnormal thermal radiation occurs, and performs turning-off control of the LED elements, or if the lamp device 14 supports dimming, the lighting control circuit performs dimming control to reduce the output of the LED elements, and suppresses the heat generation of the light-emitting module 21.

As stated above, at the time of occurrence of the abnormal thermal radiation of the lamp device 14, since the temperature rise at the place distant from the circuit component 51 having large self-heat generation occurs, when the first thermosensor 54 is arranged to be closer to the circuit component 51 having large self-heat generation than the second thermosensor 55, and the second thermosensor 55 is arranged to be more distant than the first thermosensor 54, the occurrence of the abnormal thermal radiation of the lamp device 14 can be certainly detected according to the temperature difference.

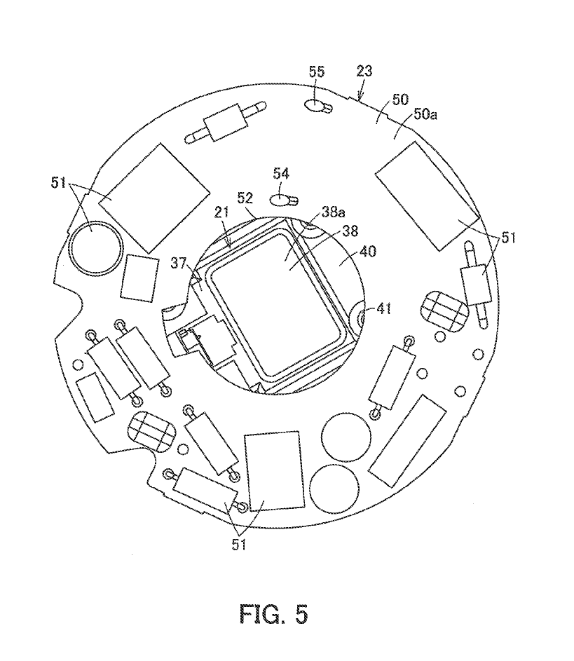

Next, a third embodiment will be described with reference to FIG. 5. Incidentally, the same component as that of the foregoing respective embodiments is denoted by the same reference numeral and the description thereof is omitted.

As shown in FIG. 5, in a circuit board 50 of a lighting circuit 23, the center side of the circuit board 50 is close to a light-emitting module 21 and is liable to be influenced by heat from the light-emitting module 21. On the other hand, a peripheral side of a circuit board 50 is distant from the light-emitting module 21, is hard to be influenced by the heat from the light-emitting module 21, and a temperature difference is liable to occur between the center side and the peripheral side of the circuit board 50.

On the circuit board 50, a first thermosensor 54 is arranged to be closer to the light-emitting module 21 than a second thermosensor 55, and the second thermosensor 55 is arranged to be more distant than the first thermosensor 54.

If a lamp device 14 is mounted on a suitable equipment device 15, or the lamp device 14 having small output is mounted on the equipment device 15 suitable for the lamp device 14 having large output, and desired thermal radiation performance of the lamp device 14 is achieved, the temperature of the light-emitting module 21 is within a normal range. Thus, a temperature difference between the temperature detected by the first thermosensor 54 close to the light-emitting module 21 and the temperature detected by the second thermosensor 55 distant from the light-emitting module 21 is within a previously set normal range. Accordingly, the lighting circuit 23 determines that the state is normal and continues lighting of LED elements.

On the other hand, if the lamp device 14 having large output is mounted on the equipment device 15 suitable for the lamp device 14 having small output and the desired thermal radiation performance of the lamp device 14 is not achieved, as compared with the case where the desired thermal radiation performance is achieved, the temperature of the light-emitting module 21 becomes high. Thus, the temperature detected by the first thermosensor 54 close to the light-emitting module 21 is liable to rise as compared with the temperature detected by the second thermosensor 55, and the temperature difference between them becomes large. Accordingly, the temperature difference between the temperature detected by the first thermosensor 54 and the temperature detected by the second thermosensor 55 exceeds the previously set normal range and falls within an abnormal range. By this, the lighting circuit 23 determines that abnormal thermal radiation occurs, and performs turning-off control of the LED elements, or if the lamp device 14 supports dimming, the lighting control circuit performs dimming control to reduce the output of the LED elements, and suppresses the heat generation of the light-emitting module 21.

As stated above, at the time of occurrence of the abnormal thermal radiation of the lamp device 14, since the temperature of the light-emitting module 21 rises, if the first thermosensor 54 is arranged to be closer to the light-emitting module 21 than the second thermosensor 55, and the second thermosensor 55 is arranged to be more distant than the first thermosensor 54, the occurrence of the abnormal thermal radiation of the lamp device 14 can be certainly detected according to the temperature difference of these.

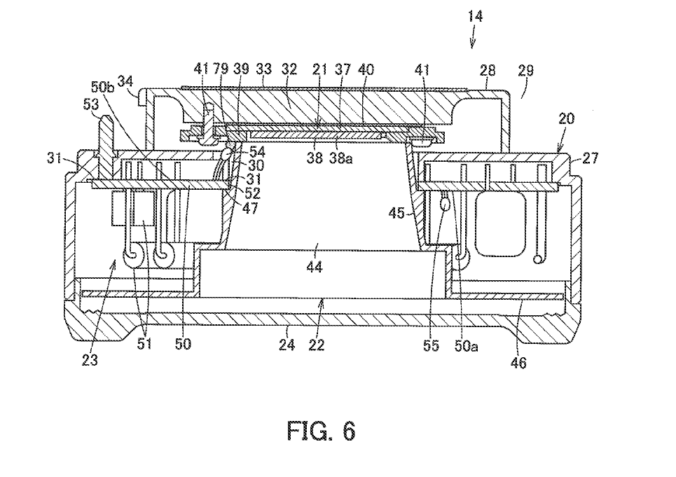

Next, a fourth embodiment will be described with reference to FIG. 6. Incidentally, the same component as the foregoing respective embodiments is denoted by the same reference numeral and the description thereof is omitted.

As shown in FIG. 6, at the time of assembling a lamp device 14, a first thermosensor 54 passes through an upper surface part of a case 27 and is arranged to be close to a light-emitting module 21, and the first thermosensor 54 is thermally connected to the light-emitting module 21 by a thermal conductive member 79 of, for example, thermal conductive resin or the like.

A place of the light-emitting module 21 to which the first thermosensor 54 is connected is a place irrelevant to light emission, such as, for example, a holder 39 or a module board 37.

A second thermosensor 55 is arranged at a place distant from the light-emitting module 21.

If the lamp device 14 is mounted on a suitable equipment device 15, or the lamp device 14 having small output is mounted on the equipment device 15 suitable for the lamp device 14 having large output, and desired thermal radiation performance of the lamp device 14 is achieved, the temperature of the light-emitting module 21 is within a normal range. Thus, a temperature difference between the temperature detected by the first thermosensor 54 to which heat from the light-emitting module 21 is conducted and the temperature detected by the second thermosensor 55 distant from the light-emitting module 21 is within a previously set normal range. Accordingly, the lighting circuit 23 determines that the state is normal and continues lighting of LED elements.

On the other hand, if the lamp device 14 having large output is mounted on the equipment device 15 suitable for the lamp device 14 having small output and the desired thermal radiation performance of the lamp device 14 is not achieved, as compared with the case where the desired thermal radiation performance is achieved, the temperature of the light-emitting module 21 becomes high. Thus, the temperature detected by the first thermosensor 54 to which the heat of the light-emitting module 21 is conducted is liable to rise as compared with the temperature detected by the second thermosensor 55, and the temperature difference between them becomes large. Accordingly, the temperature difference between the temperature detected by the first thermosensor 54 and the temperature detected by the second thermosensor 55 exceeds the previously set normal range and falls within an abnormal range. By this, the lighting circuit 23 determines that abnormal thermal radiation occurs, and performs turning-off control of the LED elements, or if the lamp device 14 supports dimming, the lighting control circuit performs dimming control to reduce the output of the LED elements, and suppresses the heat generation of the light-emitting module 21.

As stated above, at the time of occurrence of the abnormal thermal radiation of the lamp device 14, since the temperature of the light-emitting module 21 rises, if the first thermosensor 54 is thermally connected to the light-emitting module 21 by the thermal conductive member 79, and the second thermosensor 55 is arranged to be distant from the light-emitting module 21, the occurrence of the abnormal thermal radiation of the lamp device 14 can be certainly detected according to the temperature difference of these.

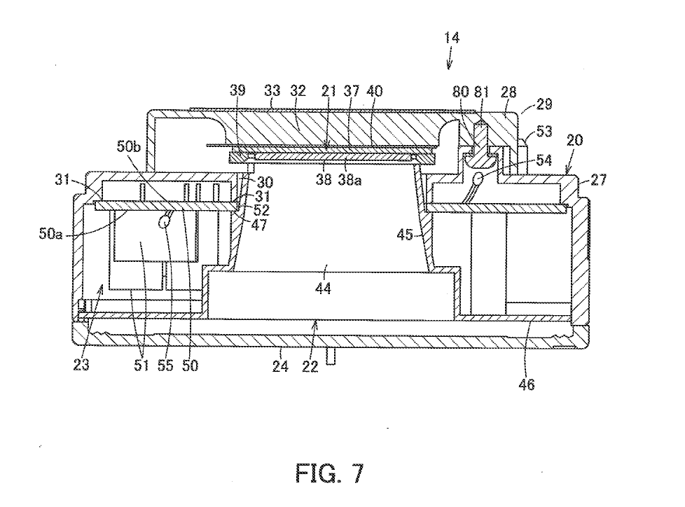

Next, a fifth embodiment will be described with reference to FIG. 7. Incidentally, the same component as that of the foregoing respective embodiments is denoted by the same reference numeral and the description thereof is omitted.

As shown in FIG. 7, a case 27 and a cap member 28 are fixed by a fixing part 80 thermally coupled to the cap member 28. As the fixing part 80, a screw 81 screwed in the cap member 28 and thermally coupled is used. The screw 81 passes through the case 27 and faces a circuit board 50.

A first thermosensor 54 is arranged to be close to the screw 81 for fixing the case 27 and the cap member 28. Incidentally, the first thermosensor 54 may be thermally connected to the screw 81 by a thermal conductive member such as, for example, thermal conductive resin.

A second thermosensor 55 is arranged at a place distant from the screw 81.

If a lamp device 14 is mounted on a suitable equipment device 15, or the lamp device 14 having small output is mounted on the equipment device 15 suitable for the lamp device 14 having large output, and desired thermal radiation performance of the lamp device 14 is achieved, the temperature of a light-emitting module 21 and the temperature of the cap member 28 to which heat from the light-emitting module 21 is conducted are within a normal range. Thus, a temperature difference between the temperature detected by the first thermosensor 54 close to the screw 81 which is threaded to the cap member 28 and to which heat from the cap member 28 is conducted and the temperature detected by the second thermosensor 55 distant from the screw 81 is within a previously set normal range. Accordingly, a lighting circuit 23 determines that the state is normal and continues lighting of LED elements.

On the other hand, if the lamp device 14 having large output is mounted on the equipment device 15 suitable for the lamp device 14 having small output and the desired thermal radiation performance of the lamp device 14 is not achieved, as compared with the case where the desired thermal radiation performance is achieved, the temperatures of the light-emitting module 21 and the cap member 28 become high. Thus, the temperature detected by the first thermosensor 54 close to the screw 81 to which the heat of the cap member 28 is conducted is liable to rise as compared with the temperature detected by the second thermosensor 55 distant from the screw 81, and the temperature difference between them becomes large. Accordingly, the temperature difference between the temperature detected by the first thermosensor 54 and the temperature detected by the second thermosensor 55 exceeds the previously set normal range and falls within an abnormal range. By this, the lighting circuit 23 determines that abnormal thermal radiation occurs, and performs turning-off control of the LED elements, or if the lamp device 14 supports dimming, the lighting control circuit performs dimming control to reduce the output of the LED elements, and suppresses the heat generation of the light-emitting module 21.

As stated above, at the time of occurrence of the abnormal thermal radiation of the lamp device 14, since the temperature of the cap member 28, together with the temperature of the light-emitting module 21, rises, if the first thermosensor 54 is arranged to be close to the screw 81 for fixing the case 27 and the cap member 28, and the second thermosensor 55 is arranged to be distant from the screw 81, the occurrence of the abnormal thermal radiation of the lamp device 14 can be certainly detected according to the temperature difference between them. Further, the screw 81 passes through the case 27 and faces the circuit board 50, and the first thermosensor 54 can easily detect the temperature of the cap member 28 through the screw 81.

Incidentally, as the fixing part 80, a rivet or another fixing component may be used in addition to the screw 81, or a portion to fix the case 27 may be provided at a part of the cap member 28. In brief, as long as the fixing part 80 passes through the case 27 and faces the circuit board 50, and the first thermosensor 54 can easily detect the temperature of the cap member 28 through the fixing part 80, any form may be adopted.

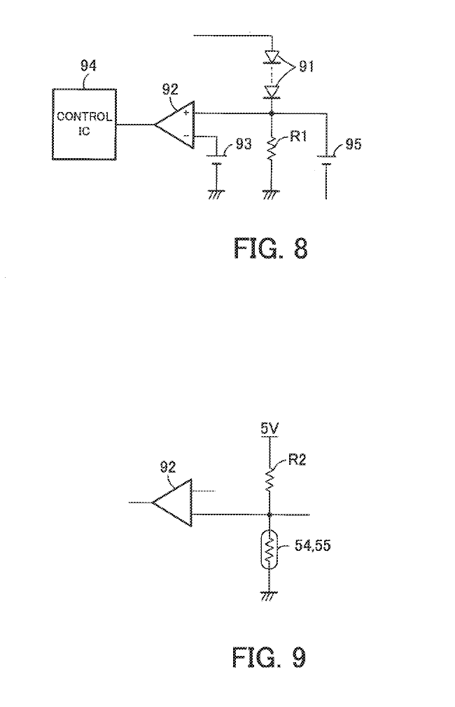

Next, FIG. 8 and FIG. 9 show embodiments in which at the time of detection of abnormal thermal radiation of a lamp device 14, a lighting circuit 23 performs dimming control of LED elements 91 as semiconductor light-emitting elements 38a. Incidentally, the same component as the foregoing respective embodiments is denoted by the same reference numeral and the description thereof is omitted.

First, in a sixth embodiment shown in FIG. 8, a resistor R1 of a voltage detection circuit is connected to the plural LED elements 91, voltage of the LED element 91 is inputted to one input terminal of a comparator 92 from a connection point between the LED element 91 and the resistor R1, and a reference voltage corresponding to a dimming level is inputted to the other input terminal of the comparator 92 from a reference voltage source 93. A comparison result of the comparator 92 is inputted to a control IC 94, and the control IC 94 controls a switching element of a DC/DC converter and performs dimming control of the LED elements 91.

When occurrence of abnormal thermal radiation is detected from a temperature difference between a first thermosensor 54 and a second thermosensor 55, in a lighting circuit 23, a dummy voltage is applied from a dummy voltage source 95 to the connection point between the LED element 91 and the resistor R1. By this, since a voltage obtained by adding the dummy voltage to the voltage of the LED element 91 is inputted to the one input terminal of the comparator 92, the control IC 94 compares the added voltage with the reference voltage, and performs dimming control to reduce the output of the LED elements 91.

Besides, in a seventh embodiment shown in FIG. 9, a series circuit of a resistor R2 and thermosensors 54 and 55 are connected to a reference voltage source of 5V, and a reference voltage is inputted to the other input terminal of a comparator 92 from a connection point between the resistor R2 and the thermosensors 54 and 55. In this embodiment, 5V is divided by the resistor R2 and the thermosensors 54 and 55, and a voltage applied to the thermosensors 54 and 55 becomes the reference voltage of the comparator 92. When the temperatures of the thermosensors 54 and 55 rise by abnormal heat generation of a light-emitting module 21, the resistance values of the thermosensors 54 and 55 are reduced, the reference voltage of the comparator 92 is lowered, and control is made so that current flowing through the light-emitting module 21 is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp device comprising:
a housing including a cap;
a light-emitting module that is arranged in the housing, and includes a module board and a semiconductor light-emitting element mounted on the module board; and
a lighting circuit that is arranged in the housing, includes a circuit board, a plurality of circuit components mounted on the circuit board, and a first thermosensor and a second thermosensor arranged at different positions on the circuit board where a temperature difference occurs at the time of lighting, and controls lighting of the semiconductor light-emitting element according to the temperature difference between the first thermosensor and the second thermosensor.

2. The device of claim 1, wherein
the circuit board includes a mounting surface on which the plurality of circuit components are mounted, and a connection surface on which the plurality of circuit components are electrically connected, and
the first thermosensor is arranged on the connection surface side of the circuit board, and the second thermosensor is arranged on the mounting surface side of the circuit board.

3. The device of claim 1, wherein the first thermosensor is arranged to be closer to a circuit component having self-heat generation among the plurality of circuit components than the second thermosensor.

4. The device of claim 1, wherein the first thermosensor is arranged to be closer to the light-emitting module than the second thermosensor.

5. The device of claim 4, wherein the first thermosensor is connected to the light-emitting module by a thermal conductive member to enable thermal conduction.

6. The device of claim 1, wherein
the housing includes a case made of a resin, and a cap member made of a metal and constituting a part of the cap, the case and the cap member are fixed by a fixing part thermally coupled to the cap member, and
the first thermosensor is arranged to be closer to the fixing part than the second thermosensor.
